(19) United States
(12) Patent Application Publication
(10) Pub. No.: US 2024/0336530 A1
(43) Pub. Date: Oct. 10, 2024

(54) BUILDING MATERIAL MADE OF INDUSTRIAL TAILINGS/WASTE

(71) Applicant: TELECOMIT PTY LTD, Broadbeach Waters, Queensland (AU)

(72) Inventor: George REINKE, Broadbeach Waters, Queensland (AU)

(73) Assignee: TELECOMIT PTY LTD, Broadbeach Waters, Queensland (AU)

(21) Appl. No.: 18/294,917

(22) PCT Filed: Jul. 29, 2022
(86) PCT No.: PCT/AU2022/050807

§ 371 Date: Feb. 2, 2024

(30) Foreign Application Priority Data
Aug. 6, 2021 (AU) 2021212149

(51) Int. Cl. C04B 28/30; C04B 18/24; C04B 18/26; C04B 20/00; C04B 111/27; C04B 111/28; C04B 111/60

(52) U.S. Cl. CPC C04B 28/30; C04B 18/248; C04B 18/26; C04B 20/0048; C04B 2111/27; C04B 2111/28; C04B 2111/60

(57) ABSTRACT

A raw material mixture for fabrication of products for flooring, retaining, and/or cladding applications, a product for flooring, retaining, and/or cladding applications, and a method of fabricating a product for flooring, retaining, and/or cladding applications. The raw material mixture comprises 40-50%, by weight, magnesium oxide derived from iron ore tailings/waste; 5-10%, by weight, binder agent; and 40-50%, by weight, fibrous stabilizing agent derived from timber yard tailings/waste.

### FIELD OF INVENTION

The present invention relates broadly to an engineered material targeted for residential and commercial use suitable for outdoor and indoor use, for example flooring, retaining, and cladding applications, and a method of manufacturing thereof. The product is targeted to not only meet advantageous use cases, but also landmark health and safety outcomes for the construction contractor/worker user.

### BACKGROUND

Any mention and/or discussion of prior art throughout the specification should not be considered, in any way, as an admission that this prior art is well known or forms part of common general knowledge in the field.

Wood fibre is commonly used as a predominant material in finished ‘fibre cement’ material products that contains crystalline silica. However, building products comprising of wood partial fibres as a predominant material are susceptible to moisture-related issues. For example, an accumulation of moisture may cause wood products to warp or twist, or irreversibly swell, and may limit the environment and settings in which building products compromising wood as the predominant material may be used.

Cement elements also used as a predominant material in finished ‘fibre cement’, that are susceptible to hazardous conditions for building contractors/workers operating with the product that has large portion of crystalline silica inclusions from 10, 20, to >40% content of the finished ‘fibre cement’ product, causing significant health risk to workers, when used with power tooling in the installation process, or power tooling in the future disassembly process.

There is a continued desire in the building industry for cost-effective building products that are easy to install and have the desirable physical properties such as high durability, high water-resistance, high fire-resistance, high termite/moth resistance, high bacteria resistance, and high heat and/or cold resistance. However, building products that generally possess these desirable characteristics are typically dangerous to install and/or have relatively higher manufacturing costs. This is the challenge with conventional ‘fibre cement’ building products, whereas this invention application has removed this health and safety risk and is providing products that are not harmful to the environment or to human health. For example, some known historical asbestos-based building products in Australia many years ago have produced disastrous effects and events to this day. Now these products have been replaced with ‘fibre cement’, that still possess similar life-threatening material components, but with much greater awareness advertised when working with these ‘fibre cement’ products for the construction contractor/worker user.

Embodiments of the present invention seek to address at least one of the above problems.

### SUMMARY

Embodiments of the present invention provide an engineered building material comprising of ‘waste material’ core ingredients of ‘Iron Ore Tailings/Waste’ mixed with ‘Timber Yard Tailings/Waste’.

In a first aspect of the present invention, a raw material mixture for fabrication of products for flooring, retaining, and/or cladding applications is provided, comprising 40-50%, by weight, magnesium oxide derived from iron ore tailings/waste; 5-10%, by weight, binder agent; and 40-50%, by weight, fibrous stabilizing agent derived from timber yard tailings/waste.

In a second aspect of the present invention, a product for flooring, retaining, and/or cladding applications is provided, comprising a cured slurry of the raw material mixture of the first aspect.

In a third aspect of the present invention, a method of fabricating a product for flooring, retaining, and/or cladding applications is provided, comprising the step of curing a slurry of the raw material mixture of the first aspect.

Other aspects, features and advantages will be apparent to those of ordinary skill in the art upon review of the description of the specific embodiments.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 is a schematic drawing illustrating a method of fabricating a product for flooring, retaining, and/or cladding applications, according to an example embodiment.

FIG. 2 is a diagram illustrating a schematic and a photograph of multi-purpose planks, according to an example embodiment.

FIG. 3 is a diagram illustrating a schematic of an industrial strength cloth and a photograph of multi-purpose boards incorporating industrial strength cloth for structural strength, according to an example embodiment.

FIG. 4A illustrates a photograph of multi-purpose boards for outdoor flooring use, according to an example embodiment.

FIG. 4B illustrates a photograph of multi-purpose boards for outdoor flooring use, according to an example embodiment.

FIG. 4C illustrates a photograph of multi-purpose boards for outdoor flooring use, according to an example embodiment.

FIG. 5 illustrates a photograph of multi-purpose planks for retaining wall outside use, according to an example embodiment.

### DETAILED DESCRIPTION

As used herein, the term “predominant” means “the largest component of”. As used herein, the term “about” when followed by a recited value means plus or minus 10% of the recited value. As used herein, the term “hydrate compound” means a hydrated ionic compound having a general chemical formula of aX·cH₂O or aX·bY·cH₂O, wherein “X” is the first ionic compound, “Y” is a second ionic compound, “a” is the number of molecules of the first ionic compound in the hydrate compound, “b” is the number of molecules of the second ionic compound in the hydrate compound, and “c” is the number of water molecules in the hydrate compound.

Example embodiments of the present disclosure can provide, for example, an engineered:
i. Flooring product [e.g., a flooring plank or board] suitable for outdoors flooring applications
ii. Retaining product [e.g., a plank or board] suitable for outdoors retaining wall, garden beds, garden edging applications
iii. Cladding product [e.g., a panel or board] suitable for indoors and outdoors panelling such as weather board external applications and internal linings panel internal applications

Embodiments of the present invention provide an engineered product for e.g. flooring, retaining, and/or cladding product comprise of core element ingredients having composition of: (i) a first hydrate compound comprising magnesium hydroxide and magnesium chloride [iron ore tailings/waste]; (ii) one or more second hydrate compounds each comprising magnesium hydroxide and magnesium sulphate [iron ore tailings/waste]; (iii) one stabilizing agent [timber yard tailings/waste]; (iv) one or more binding agent; (v) and/or for e.g. flooring and retaining products additionally either bamboo reinforcement rods/industrial cloth. The flooring and retaining products according to example embodiments can include a top decorative finish either from a mould pattern inclusion or press printed post curing phase, as a form of wood grain, predominantly pattern used as popular OAK pattern appearances as seen in indoor flooring solutions, by way of example, not limitation.

The engineered products according to an example embodiment are manufactured without incorporating PVC, LVT, and WPC (recycled or virgin) and no formaldehyde used into the material. As such the material according to example embodiment advantageously has a composition that is free of wood-plastic elements. As described herein, the material according to example embodiments does not comprise any plastic-based products or materials. The composition of the material according to example embodiments may provide one or more desired physical properties such as, but not limited to, a desired degree of water resistance, durability, and thermal expansion and contraction. The engineered material products according to example embodiments may be in the form of a plurality of interconnecting planks, boards, and panels or other relatively thin and flat shapes (herein referred to as “flooring/retaining/cladding pieces”).

Magnesium oxide is a natural metal oxide mineral that is generally resistant to mold, fungus, insects, and fire. The production of Magnesium oxide may consume less energy than production of other materials that may be used for similar applications.

For example, Magnesium oxide may be removed from iron ore as tailings at about 25% of the temperature required to form Calcium oxide, a starting material in common mortar used in ‘fibre cement’ products. When Magnesium oxide is ground into a powder and combined with water, a cement-like mixture can be formed.

In addition, it is expected that the core elements having the composition described herein according to example embodiments also have other desirable properties including, but not limited to:
i. Temperature resistance. The core elements according to example embodiments are not expected to deform at temperatures of up to 1200 degree Celsius, thereby allowing the e.g. engineered flooring and retaining product defend well against outside elements.
ii. Water resistance. The core elements according to example embodiment are not expected to be substantially change dimensions or shape when in contact with water and may therefore be used in areas of high moisture content, including direct water contact from outside elements of rain.

Structurally, the core elements according to example embodiment are mixed ingredients that set within e.g. about four (4) hour period to a solid physical state form. In an example embodiment, each flooring, retaining, and cladding product can be connected and installed together with or without the use of adhesives (e.g., glue). Preferably, the core element according to example embodiments exhibits wood-like use to enable the installer to use nails, screws, etc. and can be easily drilled with no danger of crystalline silica dust production at an occupational health and safety standard.

Engineered e.g. flooring, retaining, and cladding products according to example embodiments are generally manufactured in typical flooring, retaining, and cladding dimensions. For designs that mimic the appearance of wood e.g. flooring, retaining, and cladding, the products according to example embodiment can generally have a width of about 90 mm to 1.2 m; a length of about 1 m to 2.4 m; and a thickness that can generally range from about 6 mm to 100 mm.

Manufacturing of the Core Elements of the e.g. Flooring, Retaining and Cladding Products According to Example Embodiments

The core elements according to example embodiments are manufactured by extracted and milled magnesium oxide ‘iron ore tailing/waste’, in powder form with stabilising fibrous ‘timber yard tailing/waste’ fillings and binding agent(s). Other agent(s) can include anti-oxidation agents, catalysts, stabilizers, colorants, reinforcing agents [e.g. bamboo and/or cloth], and modifiers. Water can be added during the process.

A batch of the raw materials (for example, the materials listed in accordance with ranges shown in table 1, is mixed in a suitable mixer such as, but not limited to, an industrial mixer to create batches of raw material slurry that are collected at forming stations. Mixing preferably occurs at room temperature and lasts between about 5 and 15 minutes per batch.

TABLE 1

| Ingredient | Percent by weight |
|---|---|
| Magnesium oxide | 40-50% |
| Binding agent | 5-10% |
| Fibrous material (stabilizing agent) | 40-50% |
| catalyst | 0-1% |
| Water | 4-14% |
| Modifier and Colourant | 0-2% |

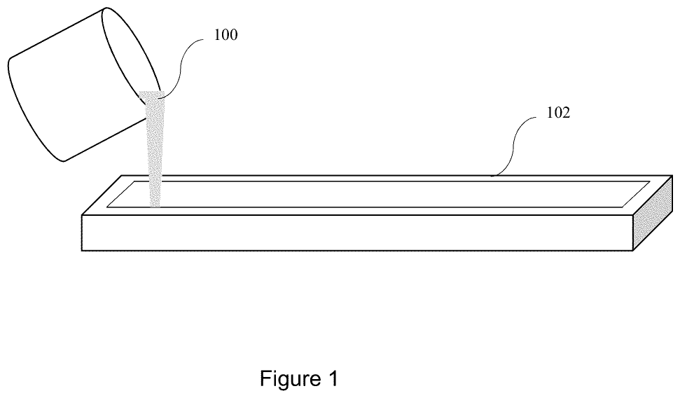

With reference to FIG. 1, in an example manufacturing process of a core element of a flooring and/or retaining product, first a layer of raw mixed material slurry 100 is poured and smoothed into a product mold(s) 102, for example in to 20%, 40%, 60%, 80% filling stages. The internal positioning of bamboo rods (not shown), and/or industrial strength cloth (not shown) layered through the thickness of the dimensions of each product variant according to various example embodiment determines the level of internal strengthening of the product(s). Generally, bamboo inserts can be at between 40% and 60% filling positioning, whereas industrial cloth can be in multiple layers at 20%, 40%, 60%, and 80% filling positioning. Within about four (4) hours the core elements according to an example embodiment have set enough to be removed from the mold 102, thus the mold 102 can be re-used for the next batch of material re-produced in the mixing process.

While heat may accelerate the curing process, the application of heat during the casting is not required. No extrusion is required in the manufacturing of the core elements according to an example embodiment.

In e.g. cladding products or other products with lower structural strength requirements the sheets of the bamboo and cloth structural/stabilizing material are not required within the core element according to example embodiments.

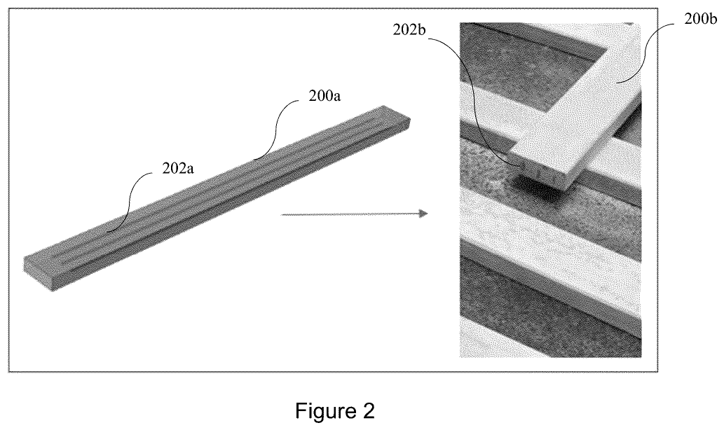

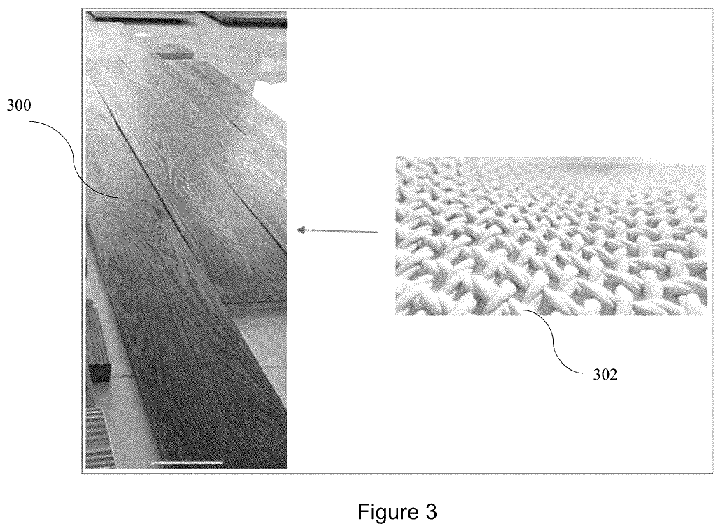

Referring to FIGS. 2 and 3, and according to an example embodiment of the present invention, there is provided an engineered multipurpose plank product 100 and engineered multipurpose board product 200, where each dimensional variant can be used for multiple purposes.

More specifically, FIG. 2 illustrates a Multi Purpose Plank 200a, b with internal bamboo rods e.g. 202a, b with or without industrial strength cloth inside the product dimensions, according to an example embodiment, of 2 m [long]×150 mm [wide]×50 mm [thick].

FIG. 3 illustrates a Multi Purpose Board 300 with internal industrial strength cloth 302 only, within the product dimensions, according to an example embodiment, of 2.4 m [long]×300 mm [wide] 30 mm [thick].

According to another example embodiment, an engineered multipurpose panel product is provided, where either internal or external building use can be dimensional manufactured to suite purpose for multiple uses, such as, but not limited to, cladding products.

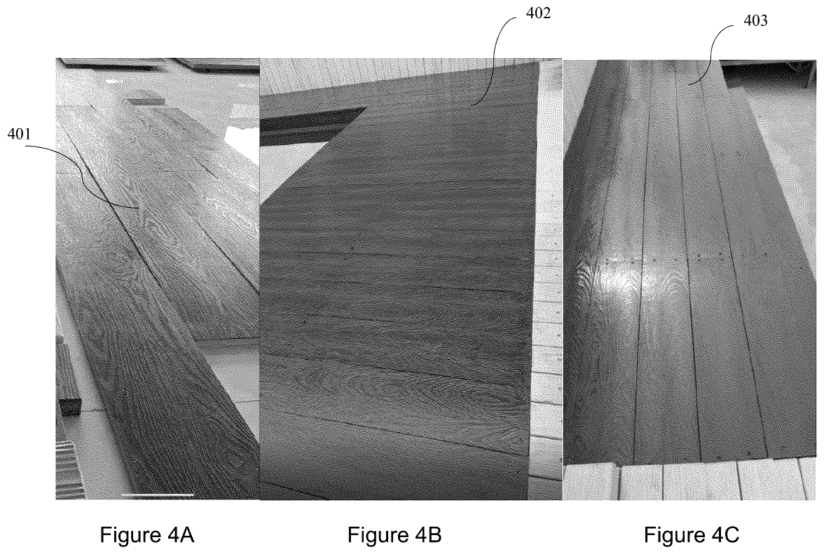

FIGS. 4A to C illustrate flooring outside use of Multi-Purpose Boards e.g. 401-403 according to an example embodiment.

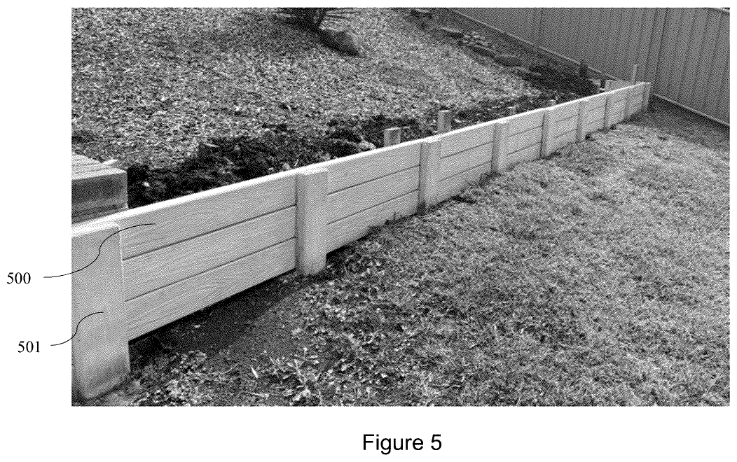

FIG. 5 illustrates retaining wall outside use of Multi-Purpose Planks e.g. 500, 501 according to an example embodiment.

In one embodiment, a raw material mixture for fabrication of products for flooring, retaining, and/or cladding applications is provided, comprising:
40-50%, by weight, magnesium oxide derived from iron ore tailings/waste;
5-10%, by weight, binder agent; and
40-50%, by weight, fibrous stabilizing agent derived from timber yard tailings/waste.

The binder agent may comprise magnesium chloride and/or magnesium sulfate derived from the iron ore tailings/waste.

The binder agent comprises a cement binder.

The raw material mixture may comprise one or more of a group consisting of anti-oxidation agents, catalysts, stabilizers, colorants, and modifiers.

The raw material mixture may comprise 4-14%, by weight, water.

In one embodiment, a product for flooring, retaining, and/or cladding applications is provided, comprising a cured slurry of the raw material mixture according to any of the example embodiments described herein.

The product may comprise bamboo rods encapsulated in the cured slurry.

The product may comprise industrialised cloth encapsulated in the cured slurry.

The product may be substantially free of silica.

The product may be substantially free of plastic based materials.

The product may be configured to limit absorption of water, swelling, deforming, or cupping.

The product may exhibit a non-deforming property at a temperature of up to 1200 degrees Celsius.

A top surface of the product may comprise a decorative finish. The decorative finish may comprise a mold patterned or press printed OAK grain pattern.

In one example embodiment, a method of fabricating a product for flooring, retaining, and/or cladding applications is provided, comprising the step of curing a slurry of the raw material mixture according to any of the example embodiments described herein.

The method may comprise the step of deriving the magnesium oxide from the iron ore tailings/waste.

The method may comprise the step of deriving the fibrous stabilizing agent from the timber yard tailings/waste.

The method may comprise the step of deriving the binder agent from the iron ore tailings/waste.

The method may comprise encapsulating bamboo rods in the cured slurry.

The method may comprise encapsulating industrialised cloth in the cured slurry.

### Industrial Applications of Example Embodiments

Embodiments of the present invention can provide engineered composite planks and boards for e.g. flooring, retaining, and/or cladding applications. In an example embodiment, an engineered composite plank and/or board includes composite core elements of >95%, by weight, Iron Ore Tailings/Waste and Timber Yard Tailings Waste with no plastic materials. Further, in an example embodiment the engineered composite planks can include encapsulated bamboo rods for structural strength, and in an example embodiment the engineered composite board can include encapsulated industrialised cloth for structural strength. Furthermore, the composite plank and board can be applied in outdoor use products enabled to withstand the harshest climate conditions such as Bush Fire Attack levels of the highest, and tropical rain conditions.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features described for different embodiments, including in the summary section, even if the feature or combination of features is not explicitly specified in the claims or the detailed description of the present embodiments.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

1. A raw material mixture for fabrication of products for flooring, retaining, and/or cladding applications, comprising:
40-50%, by weight, magnesium oxide derived from iron ore tailings/waste;
5-10%, by weight, binder agent; and
40-50%, by weight, fibrous stabilizing agent derived from timber yard tailings/waste.

2. The raw material mixture of claim 1, wherein the binder agent comprises magnesium chloride and/or magnesium sulfate derived from the iron ore tailings/waste.

3. The raw material mixture of claim 1, wherein the binder agent comprises a cement binder.

4. The raw material mixture of claim 1, comprising one or more of a group consisting of anti-oxidation agents, catalysts, stabilizers, colorants, and modifiers.

5. The raw material mixture of claim 1, comprising 4-14%, by weight, water.

6. A product for flooring, retaining, and/or cladding applications, comprising a cured slurry of the raw material mixture of claim 1.

7. The product of claim 6, comprising bamboo rods encapsulated in the cured slurry.

8. The product of claim 6, comprising industrialised cloth encapsulated in the cured slurry.

9. The product of claim 6, substantially free of silica.

10. The product of claim 6, substantially free of plastic based materials.

11. The product of claim 6, configured to limit absorption of water, swelling, deforming, or cupping.

12. The product of claim 6, exhibiting a non-deforming property at a temperature of up to 1200 degrees Celsius.

13. The product of claim 6, wherein a top surface of the product comprises a decorative finish.

14. The product of claim 13, wherein the decorative finish comprises a mould patterned or press printed OAK grain pattern.

15. A method of fabricating a product for flooring, retaining, and/or cladding applications, comprising the step of curing a slurry of the raw material mixture of claim 1.

16. The method of claim 15, comprising the step of deriving the magnesium oxide the from iron ore tailings/waste.

17. The method of claim 15, comprising the step of deriving the fibrous stabilizing agent from the timber yard tailings/waste.

18. The method of claim 15, comprising the step of deriving the binder agent from the iron ore tailings/waste.

19. The method of claim 15, comprising encapsulating bamboo rods in the cured slurry.

20. The method of claim 15, comprising encapsulating industrialised cloth in the cured slurry.
